(19) United States
(12) Patent Application Publication
(10) Pub. No.: US 2015/0002742 A1
(43) Pub. Date: Jan. 1, 2015

(54) ELECTRONIC DEVICE AND COMMUNICATION METHOD

(71) Applicant: Kabushiki Kaisha Toshiba, Tokyo (JP)

(72) Inventor: Hayato Nishimura, Tokyo (JP)

(21) Appl. No.: 13/928,083

(22) Filed: Jun. 26, 2013

(51) Int. Cl. H04N 5/445; H04N 5/44

(52) U.S. Cl. CPC H04N 5/445; H04N 5/44
USPC 348/552

(57) ABSTRACT

According to one embodiment, an electronic device includes a reception module and a display controller. The reception module is configured to receive a connection request for displaying screen information of an information processing device from the information processing device while a display is displaying video information and until power supply of the electronic device is turned off. The display controller is configured to display the screen information received from the information processing device on the display when the reception module receives the connection request.

### FIELD

Embodiments described herein generally relate to an electronic device and a communication method.

### BACKGROUND

Recently, there are tendencies of improvement in image quality of image data and performance of a portable information terminal such as a smart phone or a tablet terminal. Accordingly, there is a demand to display screen information displayed on the portable information terminal such as a smart phone or a tablet terminal, on a television display device.

Therefore, there has been proposed a technique for displaying the screen information of the portable information terminal such as a smart phone or a tablet terminal on the television display device. For example, there has been proposed a technique for transmitting the screen information using one-to-one wireless communication as Miracast (registered trademark) certified by Wi-Fi Alliance.

However, in the conventional art, a user needs to perform an operation with respect to a television display device so that the television display device is put in a state to accept connection with the portable information terminal when the user desires to display the screen information of the portable information terminal on the television display device. Therefore, the user needs to operate both the portable information terminal and the television display device, resulting in a large operational burden.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating a configuration of a communication system according to an embodiment;

FIG. 2 is an exemplary block diagram illustrating a configuration of a television display device in the embodiment;

FIG. 3 is an exemplary diagram illustrating a configuration implemented by a controller of the television display device in the embodiment;

FIG. 4 is an exemplary diagram illustrating an example of a setting screen of auto start, displayed by a display controller, in the embodiment;

FIG. 5 is an exemplary diagram illustrating an example of a list screen displayed by a portable information terminal in the embodiment;

FIG. 6 is an exemplary sequence diagram for displaying screen information of the portable information terminal on the television display device in a state in which auto start of the television display device and the portable information terminal are “OFF”, in the embodiment;

FIG. 7 is an exemplary sequence diagram for displaying the screen information of the portable information terminal on the television display device in a state in which auto start of the television display device and the portable information terminal are “ON”, in the embodiment; and

FIG. 8 is an exemplary flowchart of a display process of screen data of the portable information terminal, in the television display device, in the embodiment.

### DETAILED DESCRIPTION

In general, according to one embodiment, an electronic device comprises a reception module and a display controller. The reception module is configured to receive a connection request for displaying screen information of an information processing device from the information processing device while a display is displaying video information and until power supply of the electronic device is turned off. The display controller is configured to display the screen information received from the information processing device on the display when the reception module receives the connection request.

The following describes in details an electronic device and a communication method according to an embodiment, with reference to the accompanying drawings. In the embodiment, a television display device is used as the electronic device. However, the embodiment is not limited thereto. For example, the electronic device may be a monitoring device and the like as long as it can display screen data.

### Embodiment

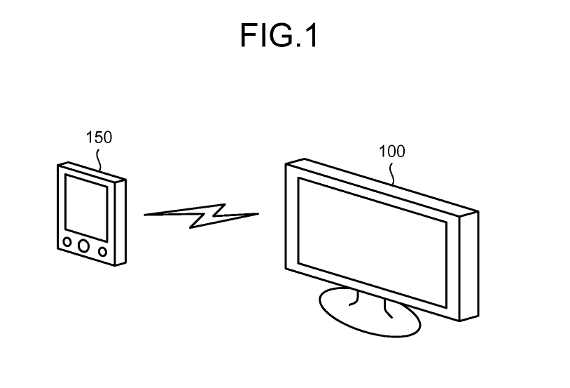

FIG. 1 is a diagram illustrating a configuration of a communication system according to an embodiment. As illustrated in FIG. 1, a portable information terminal 150 and a television display device 100 are connected via wireless communication.

In the embodiment, video transmission between the portable information terminal 150 and the television display device 100 is realized using Miracast (registered trademark). Specifically, in the embodiment, the portable information terminal 150 serves as a source device and the television display device 100 serves as a sink device to transmit video data from the portable information terminal 150 to the television display device 100 via the wireless communication. Examples of the portable information terminal 150 may include a smart phone or a tablet terminal. The portable information terminal 150 may be any device that can communicate with the sink device.

The embodiment describes an example of using the Miracast (registered trademark) as a technique for displaying the video data of the portable information terminal 150 on the television display device 100. The Miracast (registered trademark) is a transmission technique for the screen information via one-to-one wireless communication certified by Wi-Fi Alliance. At that time, the portable information terminal 150 and the television display device 100 are connected to each other via Wi-Fi Direct. When the Miracast (registered trademark) is used, as in the embodiment, the video data of the portable information terminal 150 can be displayed on the television display device 100 in approximately real time. The embodiment does not limit a connection scheme to that of the Miracast (registered trademark), and other connection schemes may be used. In addition, the connection scheme is not limited to a wireless connection, and a wired connection may be used.

The embodiment describes a scheme for interconnection when the video data of the portable information terminal (source device) 150 is displayed on the television display device (sink device) 100 by connecting the portable information terminal (source device) 150 with the television display device (sink device) 100 via wireless communication.

Conventionally, in order to display the video data of the portable information terminal on the television display device, a user needs to perform operations so as to cause the television display device to adopt a connection standby state using a remote controller and the like, and then select a connection destination (for example, the television display device 100) by the portable information terminal 150. Therefore, the user needs to operate the television display device 100 and the portable information terminal 150, resulting in a large operational burden on the user. In addition, when the television display device adopts the connection standby state, a standby screen is displayed, so that the user is hindered from viewing video data and the like by the television display device during that period.

Therefore, in the embodiment, the video data can be transmitted and received between the television display device 100 and the portable information terminal 150 without performing the operation of causing the television display device 100 to adopt the connection standby state by the user.

The television display device (sink device) 100 according to the embodiment has a setting in which the connection standby state always exists in a background. Accordingly, the television display device (sink device) 100 may reduce the operational burden in the interconnection and may improve convenience such as to reduce time for hindering the viewing.

The embodiment is described as to an example using the portable information terminal 150 as the source device and the television display device 100 as the sink device. However, the embodiment is not limited thereto.

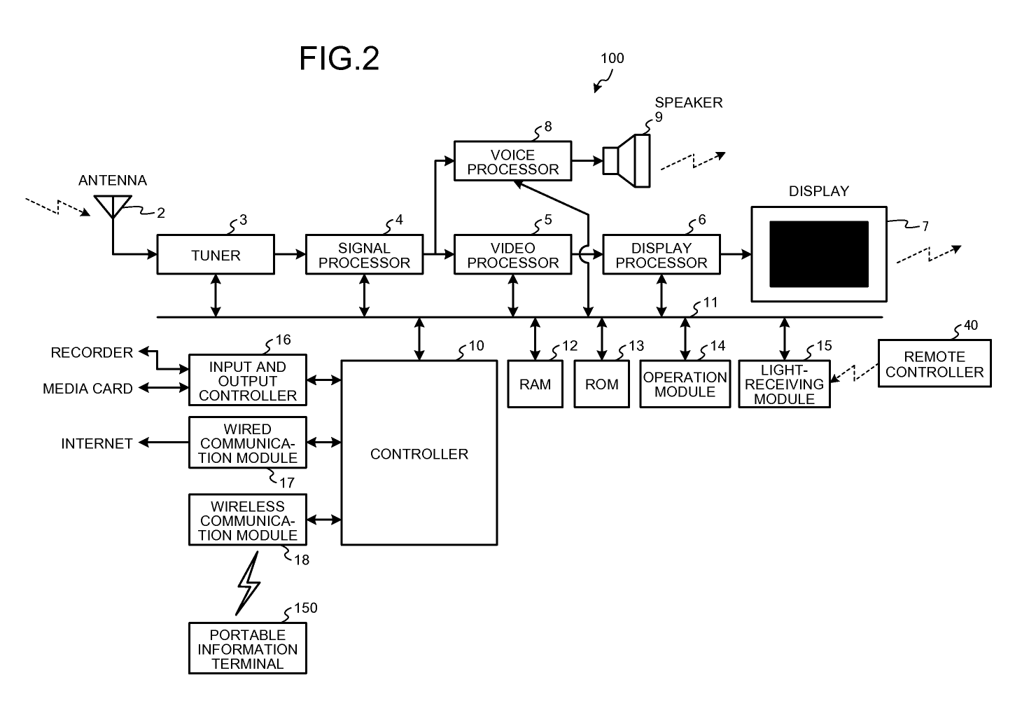

FIG. 2 is a block diagram illustrating a configuration of the television display device 100 in the embodiment. As illustrated in FIG. 2, the television display device 100 in the embodiment comprises an antenna 2, a tuner 3 for receiving digital broadcasting, a signal processor 4, an video processor 5, a display processor 6, a display 7, a voice processor 8, a speaker 9, a controller 10, a bus 11, a random access memory (RAM) 12, a read only memory (ROM) 13, an operation module 14, a light-receiving module 15, input and output controller 16, a wired communication module 17, and a wireless communication module 18.

The antenna 2 receives broadcasting satellite (BS) digital broadcasting, communications satellite (CS) digital broadcasting, terrestrial digital broadcasting, and the like. The tuner 3 selects a channel for viewing instructed by a user. The signal processor 4 extracts and processes a signal demodulated by the tuner 3 or a signal input from the input and output controller 16 as various digital signals under the control of the controller 10. The signal processor 4 separates the input signal into a video signal and a voice signal, and outputs the video signal to the video processor 5 and the voice signal to the voice processor 8.

The video processor 5 performs a process of adjusting the video signal input from the signal processor 4 to a proper screen size, and a process of removing noise included in the video signal as image quality processing for improving image quality of the video.

The display processor 6 performs a process of displaying the video signal output from the video processor 5 on the display 7. The display processor 6 further superposes an on-screen display (OSD) such as character information on the video signal output from the video processor 5. The display 7 displays the video signal on the screen. The user watches the screen of the display 7 to see a television image.

The voice processor 8 performs sound processing on the voice signal and amplifies the same. The speaker 9 outputs the voice signal as a voice. The user listens to the voice from the speaker 9 to hear the television sound.

The controller 10 controls each component of the television display device 100. The controller 10 is a processing unit that can perform sequencing, and loads a program stored in the ROM 13 into the RAM 12 to be sequentially executed. Therefore, a control signal is output to each portion of the television display device 100 and an operation of the television display device 100 is centrally controlled.

The bus 11 connects the tuner 3, the signal processor 4, the video processor 5, the display processor 6, the voice processor 8, and the controller 10 with each other and passes data between the controller 10 and the tuner 3, the signal processor 4, the video processor 5, the display processor 6, and the voice processor 8. Specifically, the bus 11 may be an IIC-BUS and the like. The RAM 12 and the ROM 13 store various pieces of data, and pass these pieces of data to/from the controller 10.

The operation module 14 is a switch that receives an operation instruction from the user. The light-receiving module 15 receives a signal transmitted by a remote controller 40 that has received the operation instruction from the user. The user can operate the television display device 100 and each device connected to the television display device 100 by operating various buttons or keys of the remote controller 40. Hereinafter, the keys and buttons are collectively referred to as a “key”.

The wired communication module 17 has an interface connecting to a LAN cable and the like, and has a function to communicate with a server connected via a network such as the Internet. The wired communication module 17 requests information from the server and receives the information transmitted from the server.

The wireless communication module 18 is interconnected with other devices that can perform wireless communication (for example, the portable information terminal 150) via a wireless LAN and the like, and transmits/receives information. The embodiment describes an example using Wi-Fi as a wireless communication technique. However, the wireless communication technique is not limited to the Wi-Fi, and other communication technique may be used. The television display device 100 may not necessarily comprise the wireless communication module 18, and alternatively, may be wirelessly connected with the portable information terminal 150 by connecting a wireless LAN dongle to a USB interface provided to the input and output controller 16.

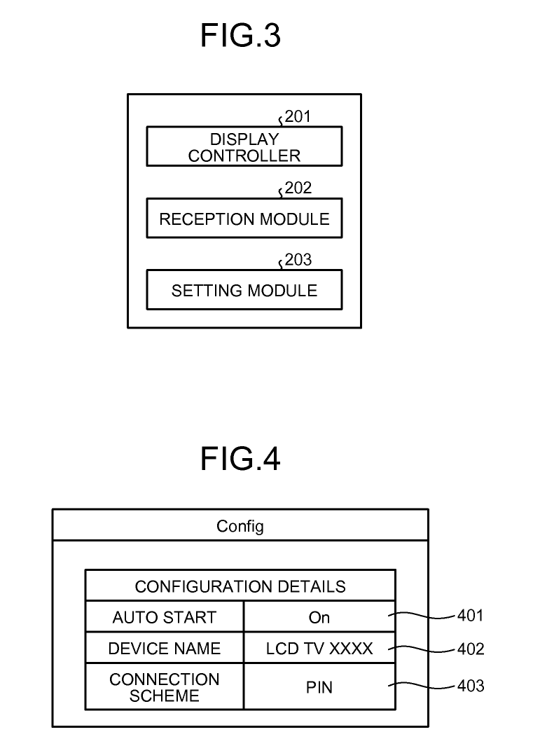

FIG. 3 is a diagram illustrating a configuration realized by executing a control program stored in the ROM 13 by the controller 10 of the television display device 100 in the embodiment. As illustrated in FIG. 3, the controller 10 comprises a display controller 201, a reception module 202, and a setting module 203.

The display controller 201 performs a process for displaying data on the display 7. When the communication is established between the television display device 100 and the source device (for example, the portable information terminal 150) using the Miracast (registered trademark), the display controller 201 displays the video data received from the source device (for example, the portable information terminal 150) via the wireless communication module 18 on the display 7.

The setting module 203 performs a setting process for waiting for the connection with the source device (for example, the portable information terminal 150). Setting information set by the setting module 203 is stored in the RAM. 12, and the setting information is referred to when the controller 10 waits for connection.

FIG. 4 is a diagram illustrating an example of a setting screen of auto start (automatic connection standby) displayed by the display controller 201 in the embodiment. In the setting screen illustrated in FIG. 4, the setting module 203 receives a setting to switch “ON” and “OFF” in an item “auto start” 401. A name that identifies the television display device 100 is indicated in an item “device name” 402. The “device name” 402 is used for identifying the connection destination by the source device (for example, the portable information terminal 150). In addition, “PIN” or “PBC” may be set in an item “connection scheme” 403.

When the item “auto start” 401 is set to “ON”, even if the received video data or the video data input from a recorder is being reproduced or displayed, the television display device 100 maintains the connection standby state, which always accepts a connection request from the source device (for example, the portable information terminal 150). On the other hand, when the item “auto start” 401 is set to “OFF”, the television display device 100 accepts the connection request from the source device (for example, the portable information terminal 150) only when receiving an operation to set the connection standby state using the remote controller 40 by the user as is conventionally done.

As described above, the setting module 203 switches the automatic reception of the connection request from the source device (for example, the portable information terminal 150) while the video data is being reproduced or displayed, and the reception of the connection request from the source device (for example, the portable information terminal 150) only when the operation to set the connection standby state is received.

The reception module 202 receives various pieces of information from the portable information terminal 150 via the wireless communication module 18. For example, when the item “auto start” 401 is set to “ON”, the reception module 202 adopts an automatic connection standby state while the display 7 displays the video data until the power supply of the television display device 100 is turned off, and always receives the connection request from the source device (for example, the portable information terminal 150).

In addition, the reception module 202 receives operation information from the remote controller 40.

When the reception module 202 receives the connection request for transmitting the video data from the portable information terminal 150, the display controller 201 displays the video data received from the portable information terminal 150 on the display 7. The connection request in the embodiment is assumed to be a connection request using a display transmission technique via one-to-one wireless communication by the Miracast (registered trademark).

The following describes the portable information terminal 150 in the embodiment. The portable information terminal 150 is assumed to be an information processing device that can perform wireless communication corresponding to the Miracast (registered trademark). When receiving a selected list of screen transmission destinations from the user, the portable information terminal 150 searches for the screen transmission destinations via wireless communication and then displays a list screen of the connection destinations.

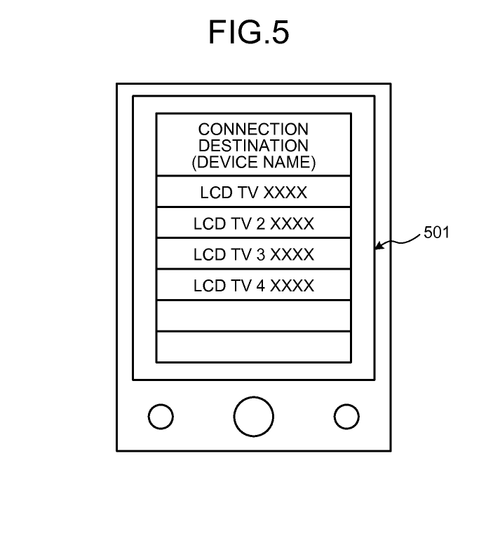

FIG. 5 is a diagram illustrating an example of a list screen displayed by the portable information terminal 150 in the embodiment. A list screen of the sink device as a transmission destination candidate of the screen data is displayed on a liquid crystal display panel 501 illustrated in FIG. 5. The sink devices displayed on the list screen are in the connection waiting state, so that they are assumed to be sink devices detected by the portable information terminal 150. The “device name” indicated in the list screen is assumed to be the same as the item “device name” 402 in FIG. 4.

When receiving the selection of the sink device from the list from the user, the portable information terminal 150 establishes a connection with the selected sink device using the Miracast (registered trademark), and starts to transmit the screen data.

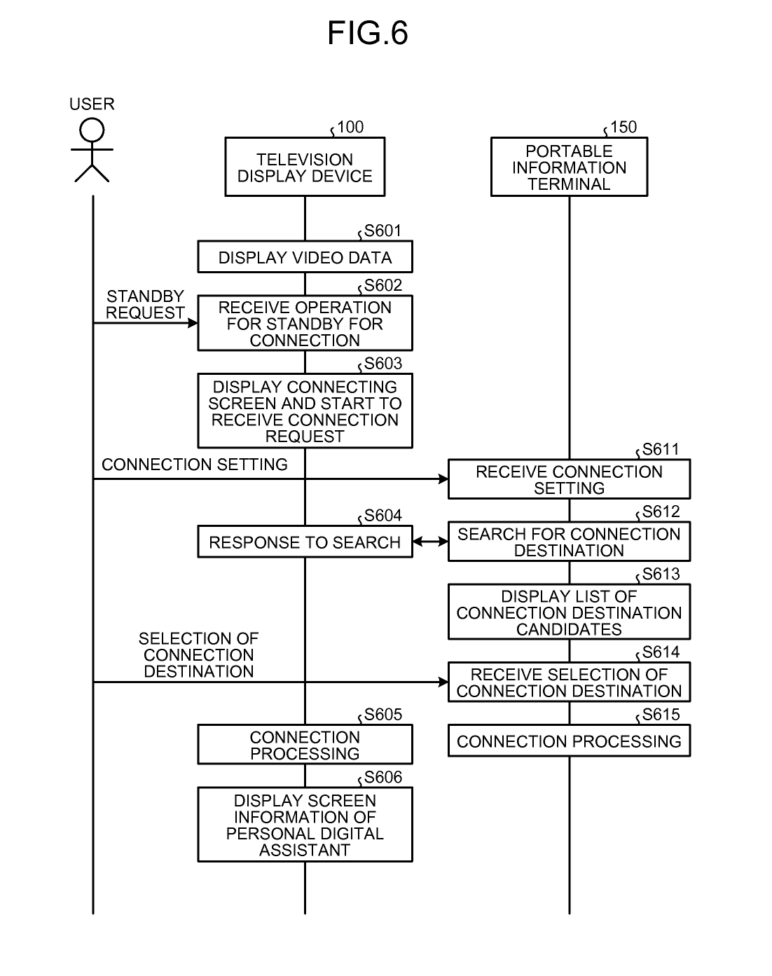

FIG. 6 is a sequence diagram for displaying the screen information of the portable information terminal 150 on the television display device 100 with auto start of the television display device 100 and the portable information terminal 150 in the embodiment being in the “OFF” state.

First, the display controller 201 of the television display device 100 displays the video data received from the antenna 2 and the like on the display 7 (S601). Next, the reception module 202 receives an operation for standby for the connection with the source device from the user via the remote controller 40 (S602).

Corresponding to the reception of the operation, the display controller 201 stops displaying the video data and displays a connecting screen, and the reception module 202 adopts the connection standby state and starts to receive the connection request (S603).

Thereafter, the portable information terminal 150 receives a setting operation for connecting to the television display device 100 from the user (S611). Then the portable information terminal 150 searches for the connection destination via wireless communication (S612).

The television display device 100 performs a response corresponding to the search by the portable information terminal 150 (S604).

The portable information terminal 150 displays a list of the connection destination candidates (the sink devices that have performed a response corresponding to the search) (S613). The portable information terminal 150 receives a selection of connection destination from the user (S614). In the example illustrated in FIG. 6, it is assumed that the television display device 100 is selected. Subsequently, connection processing is performed between the television display device 100 and the portable information terminal 150 (S605 and S615).

After the connection is established, the display controller 201 of the television display device 100 displays screen information of the portable information terminal 150 (S606).

According to the processing procedure described above, the screen information of the portable information terminal 150 may be displayed on the television display device 100. However, in the above processing procedure, when the auto start is set to “OFF”, the user needs to perform operations on the television display device 100 and the portable information terminal 150. The following describes a case where the auto start is set to “ON”.

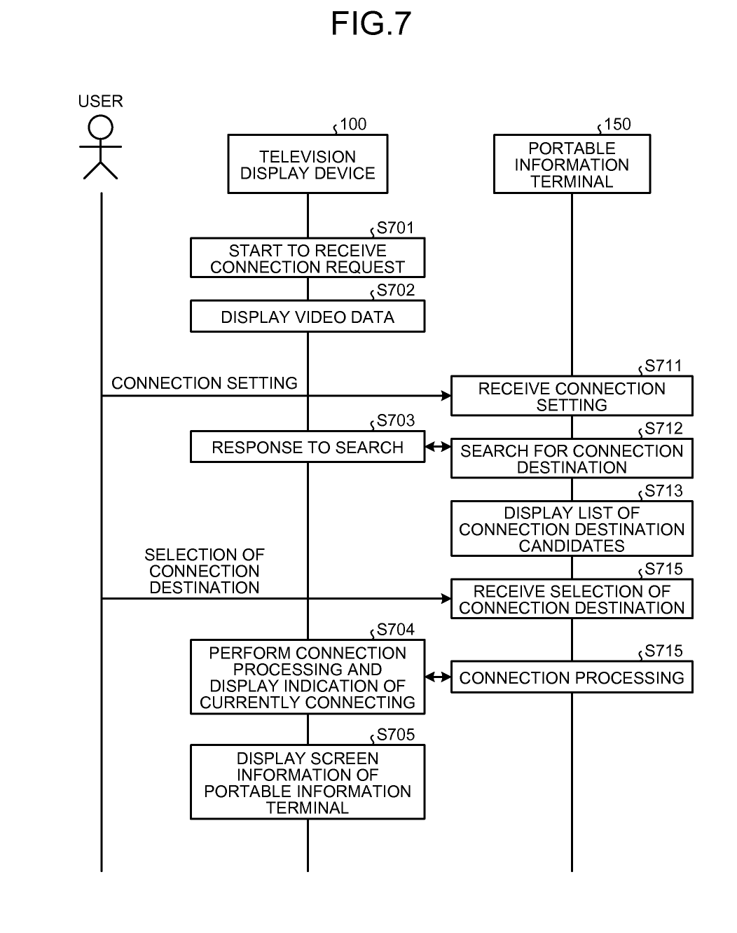

FIG. 7 is a sequence diagram for displaying the screen information of the portable information terminal 150 on the television display device 100 with the auto start of the television display device 100 and the portable information terminal 150 in the embodiment being in the “ON” state.

First, the reception module 202 of the television display device 100 adopts an automatic standby state in the background, and starts to receive the connection request (S701). The display controller 201 of the television display device 100 displays the video data received from the antenna 2 and the like on the display 7 (S702).

On the other hand, the portable information terminal 150 receives a setting operation for connecting to the television display device 100 from the user (S711). The portable information terminal 150 searches for a connection destination via wireless communication (S712).

The television display device 100 performs a response corresponding to the search by the portable information terminal 150 (S703). Thereafter, similarly to the procedures of S605 to S606 and S612 to S615 in FIG. 6, processing will be performed until the display controller 201 of the television display device 100 displays the screen information of the portable information terminal 150 (S704 to S705 and S713 to S715).

However, when the connection processing is performed at S704, indication of “connecting” is displayed by being superposed on the video data in a pop-up manner, for example, in the display controller 201. The user can thus continue to view the video data while recognizing that the connection processing is started. A display mode is not limited as described above, and the indication of “connecting” may be displayed similarly to FIG. 6. In addition, a confirmation screen indicating whether to switch to a screen display of the portable information terminal 150 may be displayed.

According to the processing procedure, the screen information of the portable information terminal 150 may be displayed on the television display device 100. In the above-described processing procedure, when the auto start is set to “ON”, the interface between the portable information terminal 150 and the television display device 100 is realized only by an operation with respect to the portable information terminal 150.

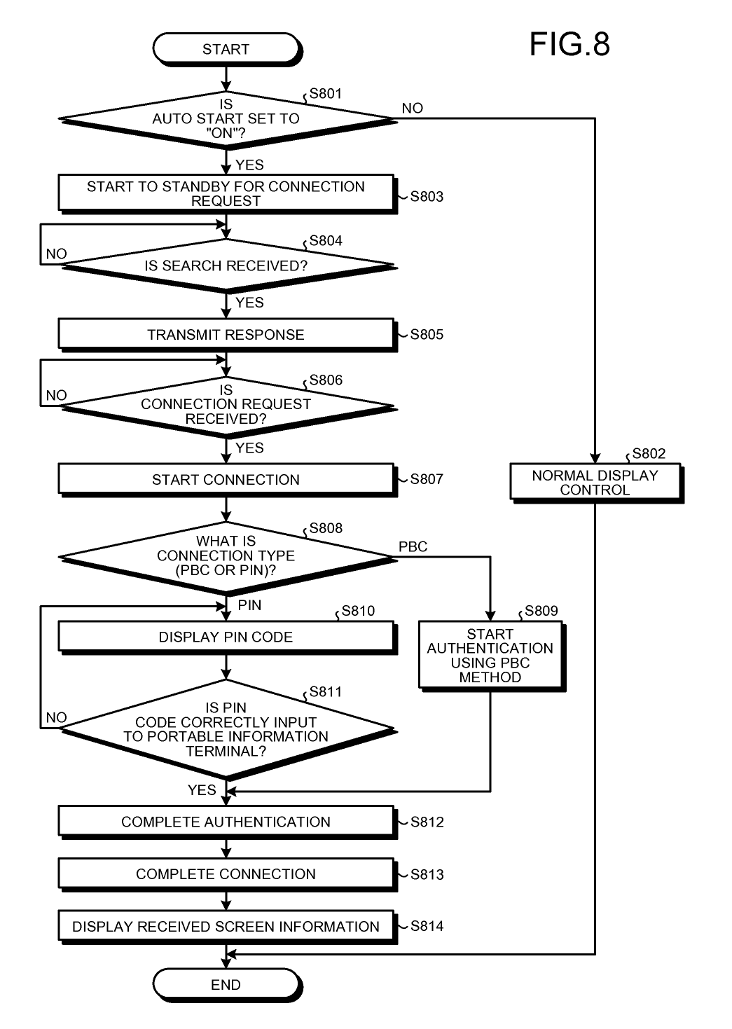

The following describes the display processing of the screen data of the portable information terminal 150 in the television display device 100 in the embodiment. FIG. 8 is a flowchart illustrating the processing procedure in the television display device 100 in the embodiment.

When the power supply is turned on, the controller 10 of the television display device 100 refers to the setting information stored in the RAM 12 and determines whether the auto start is set to “ON” (S801). When the auto start is set to “OFF” (No at S801), normal display control is performed (S802) and the process is terminated.

On the other hand, when the controller 10 determines that the auto start is set to “ON” (Yes at S801), the reception module 202 adopts the regular standby state by the Miracast (registered trademark) in the background and starts to wait for the connection request (S803). The regular standby state in the embodiment does not hinder the other functions (for example, viewing the programs) and operates in the background.

The controller 10 determines whether a search signal is received from the source device via the wireless communication module 18 (S804). When the search signal is not received (No at S804), the controller 10 does not perform specific processing and maintains the standby state.

On the other hand, when receiving the search signal (Yes at S804), the controller 10 performs a response corresponding to the search signal (S805). From this point, the transmission source of the search signal can display the television display device 100 as the connection destination candidate.

The reception module 202 determines whether the connection request is received from the source device (for example, the portable information terminal 150) (S806). When the connection request is not received (No at S806), the reception module 202 does not perform specific processing and maintains the standby state.

On the other hand, when receiving the connection request (Yes at S806), the controller 10 starts to connect with the transmission source of connection supply (for example, the portable information terminal 150) (S807). The controller 10 determines what the connection type is, set by the setting information (S808). When the connection type is determined as PBC (PBC at S808), authentication using a PBC method is started (S809). In a case using the PBC method, a screen is not specifically displayed, and connection authentication is performed internally.

When the controller 10 determines that the connection type is PIN (PIN at S808), the display controller 201 performs display control on the display 7 using a PIN code (S810). Accordingly, the user inputs the PIN code to the portable information terminal 150. Thereafter, the portable information terminal 150 performs authentication using the input PIN code on the television display device 100.

The reception module 202 determines whether the PIN code is correctly input to the portable information terminal 150 based on the authentication by the portable information terminal 150 (S811). When it is determined that the PIN code is not correctly input (No at S811), the reception module 202 continues to perform the display control of the PIN code by S810. When it is determined that the PIN code is correctly input (Yes at S811), authentication using the input PIN code is performed, and the process proceeds to S812.

The controller 10 completes the authentication with the portable information terminal 150 (S812). The connection processing between the controller 10 and the portable information terminal 150 is completed (S813).

The display controller 201 displays the screen data received from the portable information terminal 150 (S814).

According to the processing procedure described above, the television display device 100 may display the screen information of the portable information terminal 150.

### Modification

The first embodiment describes an example in which the connection using the Miracast (registered trademark) is realized when the power supply is ON. However, the embodiment is not limited to the case where the power supply is ON. Alternatively, wireless connection with the portable information terminal 150 can be made when the power supply is OFF. Therefore, in the television display device 100 in the modification, even if the power supply is OFF, the power supply is turned on when the connection request from the portable information terminal 150 is received and the screen information is displayed.

The television display device 100 in the modification is assumed to have the similar configuration to the first embodiment, so that description thereof will be omitted. In the television display device 100 in the modification, even if the power supply is “OFF”, power is supplied to the wireless communication module 18 and the controller 10 when the auto start is set to “ON”.

Accordingly, even when the power supply of the television display device 100 is OFF, the reception module 202 can wait for the connection request. The reception module 202 performs control of turning on the power supply so that power is supplied to the entire television display device 100 when the connection request is received. Subsequent processes are similar to those of the first embodiment, so that description thereof is omitted. Accordingly, in the television display device 100 in the modification, even if the power supply is OFF, the power supply is automatically turned on when the connection request from the portable information terminal 150 is received, and the screen information of the portable information terminal 150 is displayed on the display 7. Accordingly, a further operational burden on the user can be reduced.

The embodiment and the modification described above relate to a control method when the screen information of the source device is displayed on the sink device via a wireless LAN. In the above embodiment and modification, the television display device 100 as the sink device is provided with a mode of always being in the connection standby state in the background. An operation to cause the standby state by operating the sink device before the connection is not necessary unlike in the related art, so that an operational burden can be reduced.

In the conventional method, when the sink device is caused to be in the standby state, a connection standby screen is displayed and the display of the video data is stopped. During that time, a user is hindered from viewing the video data. In contrast, in the embodiment, the video data is continued to be displayed after receiving the connection request when the auto start is “ON”, so that the time hindered from viewing may be reduced.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electronic device comprising:
a display;
a reception module to receive a connection request from an information processing device while the display is displaying video information and until power supply of the electronic device is turned off, the connection request to establish a connection between the electronic device and the information processing device and to display screen information of the information processing device; and
a display controller to display the screen information received from the information processing device on the display when the reception module receives the connection request.

2. The electronic device of claim 1, further comprising a setting module to switch a setting to receive the connection request between a first setting in which the connection request is received during when the display is displaying the video information and a second setting in which the connection request is received only when an operation of a standby request for the connection request is received via an interface.

3. The electronic device of claim 2, wherein the display controller is further configured to display setting screen information for the switching between the first setting and the second setting.

4. The electronic device of claim 1, wherein the reception module operates on standby for the connection request even when the power supply of the electronic device is off, and to turn on the power supply of the electronic device when the connection request is received.

5. The electronic device of claim 1, wherein the connection request received by the reception module from the information processing device is a connection request using a display transmission technique via one-to-one wireless communication.

6. A communication method performed in an electronic device, the communication method comprising:
receiving a connection request from an information processing device while a display of the electronic device is displaying video information and until power supply of the electronic device is turned off, the connection request to establish a connection between the electronic device and the information processing device and to display screen information of the information processing device; and
displaying the screen information received from the information processing device on the display when the connection request is received.
